(19) United States
(12) Patent Application Publication
(10) Pub. No.: US 2009/0119769 A1
(43) Pub. Date: May 7, 2009

(54) CROSS-SITE SCRIPTING FILTER

(75) Inventors: David A. Ross, Redmond, WA (US); Steven B. Lipner, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/935,323

(22) Filed: Nov. 5, 2007

(51) Int. Cl. G06F 21/00

(52) U.S. Cl. 726/13

(57) ABSTRACT

A reflected cross-site scripting (XSS) mitigation technique that can be implemented wholly on the client by installing a client-side filter that prevents reflected XSS vulnerabilities. XSS filtering performed entirely on the client-side enables web browsers to defend against XSS involving servers which may not have sufficient XSS mitigations in place. The technique accurately identifies XSS attacks using carefully selected heuristics and matching suspect portions of URLs and POST data with reflected page content. The technique used by the filter quickly identifies and passes through traffic which is deemed safe, keeping performance impact from the filter to a minimum. Non-HTML MIME types can be passed through quickly as well as requests which are same-site. For the remaining requests, regular expressions are not run across the full HTTP response unless XSS heuristics are matched in the HTTP request URL or POST data.

### BACKGROUND

Cross-site scripting (XSS) is a well documented class of web application security vulnerability. The goal of an XSS attack is to enable the attacker to control the relationship between a user and a website or web application that the user trusts.

In the most common scenario, XSS involves a malicious URL that is constructed such that an embedded client-side script in the URL is repeated in the HTML (hypertext markup language) output of a generated web page. When a victim client navigates to the URL using the client web browser, the resulting client-side script executes in the security context of the session shared with a trusted server. A hypothetical XSS attack might proceed as follows: the victim is enticed to click on a link in a mail message; the link navigates the victim's browser to what appears to be a well-known and trusted website; however, the URL link includes a malicious script block; the web page generated by the trusted site echoes the script block from the URL containing a malicious script evil.js, causing the client to load the evil.js script from evil.com. The malicious script displays its own news article on the page. The victim believes that the news article is genuine content from the trusted site because the domain of the trusted site appears in the browser's address bar.

Spoofing content on trusted sites can be fairly benign; however the object model exposed by modern web browsers enables the potential for more sophisticated attacks. Beyond content spoofing, these attacks include: stealing cookies, including session cookies which can allow an attacker to log-on to the web application remotely as the victim user; monitoring keystroke input to the malicious website; and performing actions on the website on behalf of the user (e.g., an XSS attack on Windows Live Mail™ might enable an attacker to read and forward e-mail messages, set new calendar appointments, etc.).

Recently, a website began assembling an archive of XSS issues reported against websites across the Internet. Over 10,000 voluntarily submitted XSS issues against websites have been archived. Attackers can freely peruse the archive for an XSS attack to use on any particular website. Traditional techniques for mitigating XSS occur not at the client, but at the server using character encoding, safe libraries, and web application scanning technology. As previously noted, the website servers are under pressure from myriad of possible ways in which XSS attacks can be applied. Moreover, even though some XSS mitigation techniques that have been proposed involve client-side components, none are capable of effectively filtering XSS attacks wholly on the client.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed cross-site scripting (XSS) mitigation technique focuses wholly on the client by installing a client-side filter that removes the XSS vulnerabilities that exist today. XSS filtering performed entirely on the client-side enables web browsers to defend against XSS involving servers which may not have sufficient XSS mitigations in place. The pervasive nature of XSS on modern dynamic websites makes this a necessity.

The technique accurately identifies XSS attacks by matching suspect portions of URLs and POST data with reflected page content. The technique used by the filter quickly identifies and passes through traffic which is deemed safe, keeping performance impact from the filter to a minimum. Non-HTML MIME types can be passed through quickly as well as requests which are same-site. For the remaining requests, regular expressions (alphanumeric character strings used to match other strings) are not run across the full HTTP response unless XSS heuristics are matched in the HTTP request URL.

The filter neutralizes XSS attacks in a way that does not open new XSS vulnerabilities that would not otherwise exist. Moreover, the filter neutralizes XSS in a way that does not adversely affect the web browsing experience in the unlikely event that benign content is flagged as an XSS attack.

The input to the filter is the full HTTP request/response traffic. Accordingly, in alternative implementations, the technique can function at a web proxy server or on a web server. In this capacity, the filter functions as a generic web application firewall capable of blocking XSS but without having specific application level knowledge.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a system for filtering cross-site scripting (XSS) attacks.

FIG. 2 illustrates a more detailed block diagram of the XSS filter logic.

FIG. 3 illustrates an exemplary set of heuristics that can be employed and extended as new threats are detected.

FIG. 4 illustrates a browser implementation that includes the filter component for filtering XSS attacks.

FIG. 5 illustrates a server implementation where the filter logic is applied at a server.

FIG. 6 illustrates a server implementation where the filter logic is applied at a proxy server.

FIG. 7 illustrates a computer-implemented method of filtering a reflected XSS attack.

FIG. 8 illustrates an exemplary method of employing an XSS filter.

FIG. 9 illustrates a block diagram of a computing system operable to execute XSS filtering in accordance with the disclosed architecture.

FIG. 10 illustrates a schematic block diagram of an exemplary computing environment for filtering reflected XSS attacks.

### DETAILED DESCRIPTION

The disclosed architecture is a reflected cross-site scripting (XSS) mitigation filtering technique that focuses wholly on the client. The filter is performant, compatible with websites, and secure. Compatibility refers in part to the filter preventing the breaking of websites. The browser employs the filtering technique as an enabled-by-default feature to provide the capability of protecting a relevant number of users. Thus, if the filter were to break even a small number of websites, it would be difficult or impossible for the filter to be implemented as the enabled-by-default feature.

The client-side filter defends against XSS attacks involving servers which may not have sufficient XSS mitigations in place. The technique accurately identifies XSS attacks by matching suspect portions of URLs and POST data with reflected page content using heuristics and heuristic-generated signatures. The filter quickly identifies and passes through traffic which is deemed safe, minimizing the performance impact of the filter on client processes. The client-side XSS filter is in a position to observe and intercept HTTP requests and responses for specific MIME types from the browser to the web server. Non-HTML (hypertext markup language) MIME (multipurpose Internet mail extensions) types can be passed through quickly as well as requests which are same-site. For the remaining requests, regular expressions are not run across the full HTTP response unless XSS heuristics are matched in the HTTP (hypertext transfer protocol) request URL.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

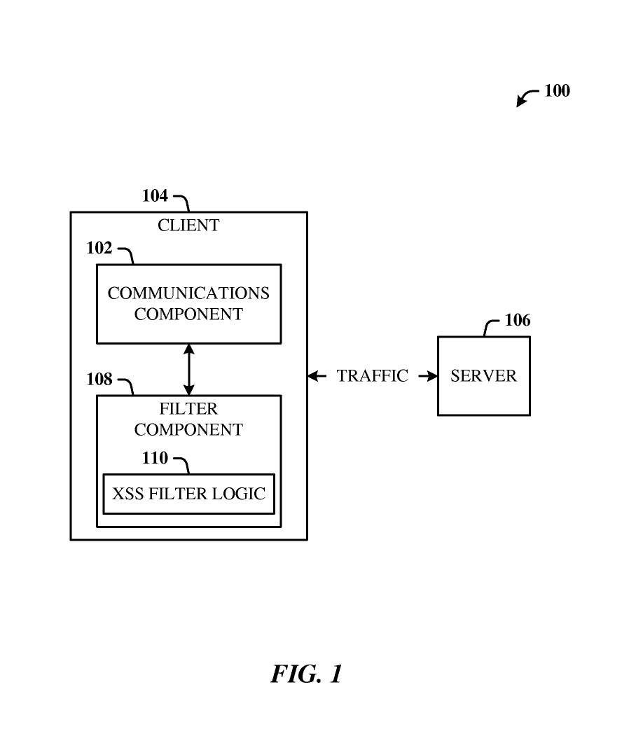

FIG. 1 illustrates a system 100 for filtering XSS attacks. The system 100 includes a communications component 102 of a client 104 for processing traffic between the client 104 and a server 106, and a filter component 108 for filtering a reflected XSS attack from the traffic using XSS filter logic 110. The communications component 102 can be a browser that sends traffic in the form of an HTTP request to the server 106, and the filter component 108 operating on the client 104 filters the XSS attack from the return traffic, the attack being part of the HTTP response.

Where the filtering occurs wholly on the client 104, the communications component 102 is a browser of the client that sends an HTTP request to the server 106 and the filter component 108 operates on the client 104 to filter the XSS attack. Implementations on the server-side are described below.

The traffic can be HTTP request/response traffic where the filter component 108 analyzes the request traffic to confirm the XSS attack in the response traffic. This can be accomplished by the filter component 108 analyzing a referer header of the request traffic. The filter component 108 includes and processes heuristics against outgoing traffic (e.g., HTTP request) of the client 104 to the server 106 to generate signatures, and processes the signatures against the incoming traffic (e.g., HTTP response) from the server 106 to filter the XSS attack.

Heuristics processing includes the filter component 108 choosing one or more neuter characters. Identified neuter characters in the HTTP response are replaced with the neuter replacement character. In other words, one or more heuristics are run over across the input URLs and POST data resulting in signatures being generated. The process of generating the signatures is what identifies the neuter characters. The signatures are then run across incoming traffic from the server 106 to determine occurrence of the XSS attack. This is described in greater detail herein. In one implementation, the filter component 108 processes incoming traffic for an XSS attack based on the content of the incoming traffic having a MIME type that would result in the response rendering as HTML in the browser.

In an alternative implementation, the filter component 108 is part of the client browser and observes all input to the browser's script engine. When a script block is identified, the filter component 108 then goes back to scan the original outgoing traffic (e.g., the original URL and/or POST data) for the request to find the script that is about to be executed. If the script is found, and is a mismatch, it is a same-site script and can be allowed through; however, if there is a match, it will be assumed to be a reflected XSS attack, in which case, it will be filtered, or exposed to further processing.

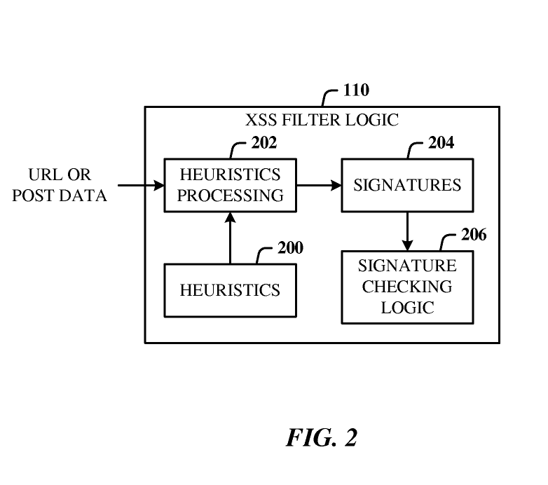

FIG. 2 illustrates a more detailed block diagram of the XSS filter logic 110. The filter logic 110 is illustrated as including a set of heuristics 200 that can be applied to outgoing traffic (e.g., from the client browser) via a heuristics processing component 202. Processing of the heuristics 200 results in signatures 204 that can then be applied against incoming traffic (e.g., to the client browser) using signature checking logic 206.

XSS analysis can be a two-step process: first, build signatures based on the heuristics on incoming request traffic (e.g., URL or post data), and second, process the signatures against the response traffic to find a match (also referred to as reflected back). In other words, it is not just looking for content in the URL or in post data going up to the server (the HTTP request) from the client, but also is identifying that the same data is or is not being replayed into the HTTP response. Inferior filters are “one step” that look for badness in the request and make no attempt to match the request with content that was echoed back and that will execute.

One XSS attack approach is to game the filter by convincing the filter to eliminate characters such as double quotes that would result in enabling XSS that would not otherwise be possible. A countering technique to this attack is to make a good selection of the characters in the HTTP response that will be modified. This selective neutering of only the XSS portion of otherwise legitimate web pages, blocks XSS with minimal interference to the user. This is in contrast to blocking pages and/or requiring significant levels of user interaction. Characters will not be selected that affect the execution or that would enable this type of attack. A hash symbol can be employed which effectively stops script from executing immediately when the parser encounters it. Thus, the threat is mitigated by intelligent selection of the characters that are going to be replaced in the response as problematic.

A second attack technique is to game the filter by adding characters to a request which might get dropped or translated when the characters are replayed to the server or replayed from the server. An attack might involve a script tag that is embedded in the URL. This is in fact a common form of attack. Accordingly, the filter logic 110 analyzes the URL or post data for a potential script tag. If that script tag gets replayed, the logic 110 needs to be able to identify the same tag or the same text in the response. If the attacker determines that a strange Unicode character or an exclamation mark can be added, for example, in the middle of the script tag, and the server drops the character or mark before replaying it, the filter can be bypassed because the filter is looking for a script tag, and not a script tag with an exclamation mark in the middle.

A way to defeat this second attack technique is by developing the signatures 204 based on the first stage (the request) of the filtering, that is, making the signatures 204 not an exact match of what is expected to be in the HTTP response, but a match of the important characters that make up the essence of the XSS attack. In other words, the insertion of one or more extra characters in the request will not defeat the effectiveness of the filter logic.

The heuristics 200 are a predetermined set, and are employed in the first stage of analyzing the request traffic (the URL or post data) for script tags and/or expressions that might cause script execution in the browser. The identification of such information is not definitive. Thus, the information found in the heuristics 200 is used to generate the signatures 204 which serve as the evidence of the XSS attack replayed in the HTTP response. As the attacks evolve over time, different heuristics can be coded and added to the heuristics 200 for identifying these new attacks. The new heuristics can be provided in the form of updates to the filter logic 110.

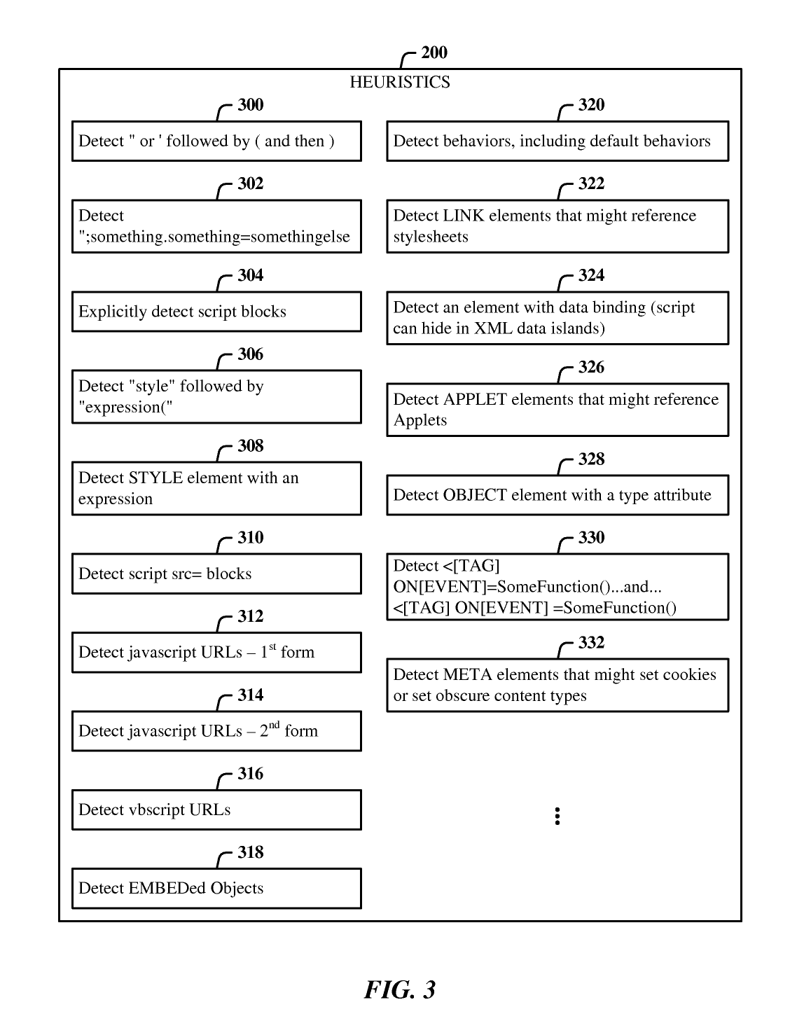

FIG. 3 illustrates an exemplary set of heuristics 200 that can be employed and extended as new threats are detected. The heuristics for scanning an URL include, but are not limited to, the following:

Heuristic 300 detects ″ or ′ followed by (and then). The initial ″ or ′ are followed by a non-alphanumeric to match. This prevents it from inadvertently matching URLs. Heuristic 302 detects″;something.something=somethingelse; heuristic 304 explicitly detect script blocks; heuristic 306 detects “style” followed by “expression(”; heuristic 308 detects a STYLE element with an expression; heuristic 310 detects script src=blocks; heuristic 312 detects javascript URLs of a first form; heuristic 314 detects javascript URLs of a second form; heuristic 316 detects vbscript URLs; heuristic 318 detects EMBEDed objects; heuristic 320 detects behaviors, including default behaviors; heuristic 322 detects LINK elements that might reference stylesheets; heuristic 324 detects an element with data binding (script can hide in XML data islands); heuristic 326 detects APPLET elements that might reference Applets; heuristic 328 detects an OBJECT element with a type attribute; heuristic 330 detects <[TAG] ON[EVENT]=SomeFunction( ) . . . and . . . <[TAG] ON[EVENT]=SomeFunction( ), and heuristic 332 detects META elements that might set cookies or set obscure content types.

Other heuristics can be added, as new threats are detected. For example, a heuristic for detecting block FRAMEs/IFRAMEs can be provided. Various permutations of the input can be pushed through the signature generation process as may be necessary. For example, some web server platforms silently coalesce parameters with the same name. For example, http://microsoft.com/microsoft.asp?Name=asdf&Name=zzzz might result in the Name variable replaying as “asdfzzzz”. Attacks can leverage this server-side behavior to game the filter. Thus, the filter performs similar parameter name coalescing to mimic this server-side behavior. In addition to pushing the original URL through the signature generation process, if there are parameters with the same name, it will coalesce them and push the resulting URL through the signature generation process. In the example above, the secondary URL would be pushed through the signature generation process: http://microsoft.com/microsoft.asp?Name=asdf,zzzz.

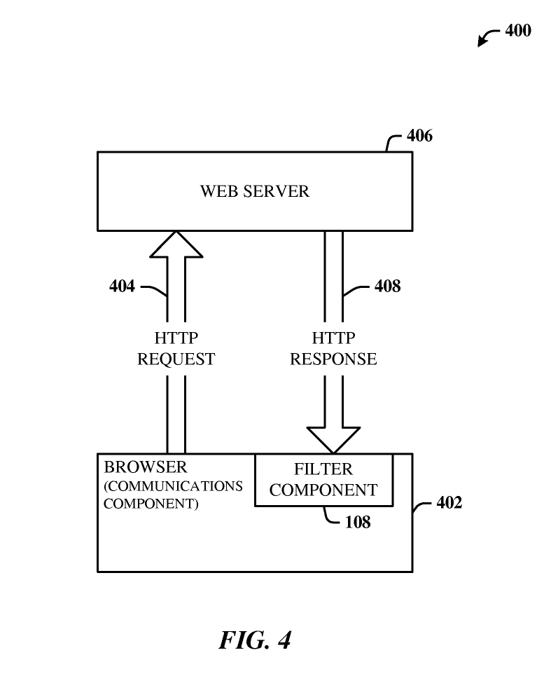

FIG. 4 illustrates a browser implementation 400 that includes the filter component 108 for filtering XSS attacks. A client browser 402 (a communications component) sends an HTTP request 404 to a web server 406. The filter component 108 processes the request by applying heuristics to URL and/or POST data in the request to generate signatures. If the heuristics indicate that the request is suspect, the filter component 108 also applies the signatures to the HTTP response 408, thereby filtering out a reflected XSS attack.

In an alternative embodiment, the filter in the browser will allow the server to disable the XSS filter for a particular response by sending a specific HTTP response header. Unless there is a very specific and fairly rare vulnerability (e.g., “response splitting” vulnerability) it will not be possible for an attacker to spoof this header and thus disable the filter. This feature is intended as an application compatibility measure to ensure that websites that do server-side XSS filtering or just do not want the client-side XSS filter to affect the server in any way, can disable the functionality in the browser.

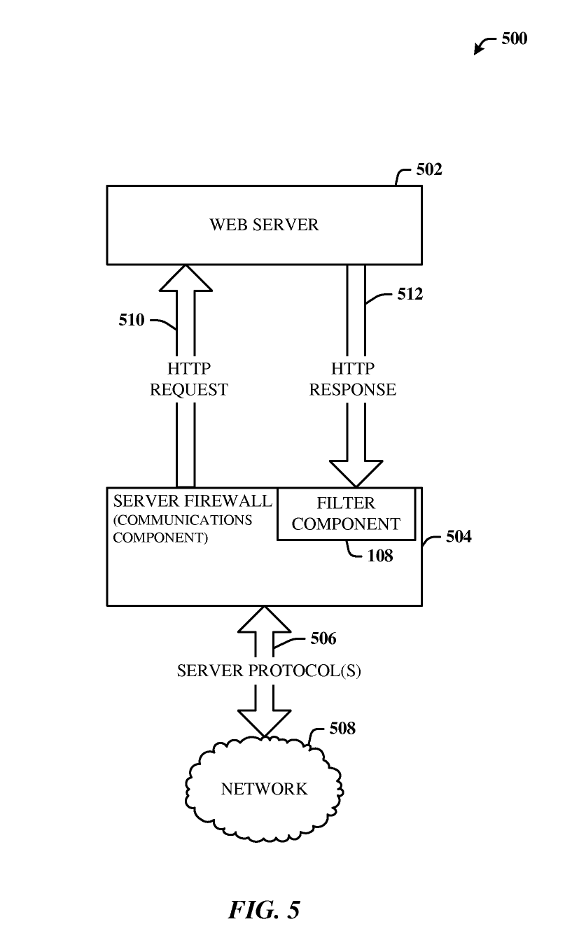

FIG. 5 illustrates a server implementation 500 where the filter logic is applied at a web server 502. Here, the filter component 108 can be included as part of a server firewall application 504 (the communications component in this scenario). The firewall application 504 operates on one or more server protocols 506 that facilitate communicating data over a network 508. The traffic between the firewall application 504 and the server 502 can include HTTP request traffic 510 and HTTP response traffic 512. The filter component 108 operates on the request traffic 510 using the heuristics to generate the signatures for processing in the response traffic 512. In other words, the communications component is the firewall application 504 at the server 502 that processes the traffic, and the filter component 108 operates as part of the firewall application 504 to filter the XSS attack.

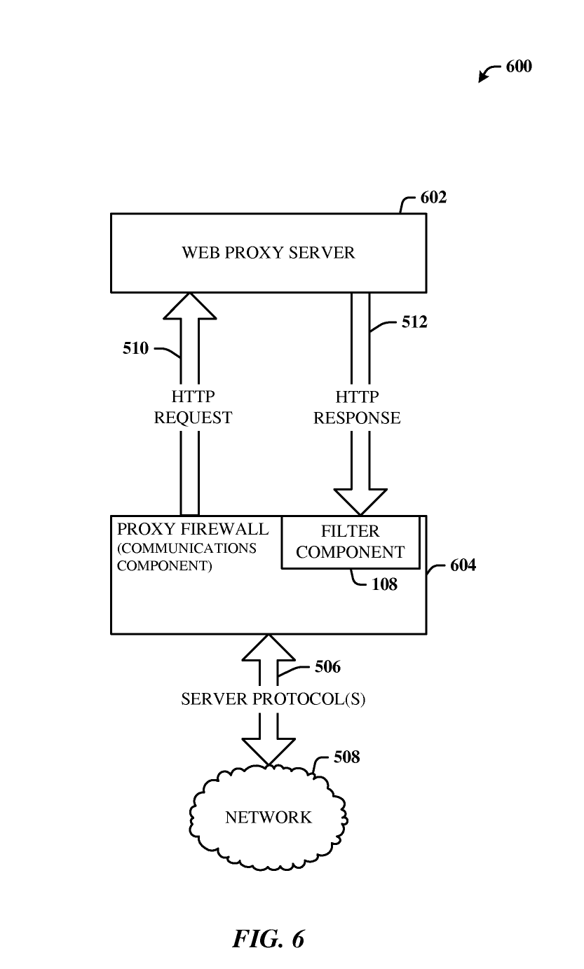

FIG. 6 illustrates a server implementation 600 where the filter logic is applied at a proxy server 602. Here, the filter component 108 can be included as part of a proxy server firewall 604 (the communications component in this scenario). The proxy firewall 604 operates on the one or more server protocols 506 that facilitate communicating data over the network 508. The traffic between the proxy firewall 604 and the proxy server 602 can include the HTTP request traffic 510 and HTTP response traffic 512. The filter component 108 operates on the request traffic 510 using the heuristics to generate the signatures for processing in the response traffic 512. In other words, the communications component is the proxy firewall 604 at the proxy server 602 that processes the traffic, and the filter component 108 operates as part of the proxy firewall 604 to filter the XSS attack.

This same configuration for the server implementation 600 can apply to a reverse proxy server scenario for use by a bank of web servers. Thus, all inbound traffic to the bank of servers first hits the proxy which can then handle the traffic at the proxy, or forward the traffic to the designated server(s) for further processing. Accordingly, requests passed from the proxy to the web server(s) are checked along with the response traffic to confirm the presence of an attempted XSS attack, and more completely, block the XSS attack.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

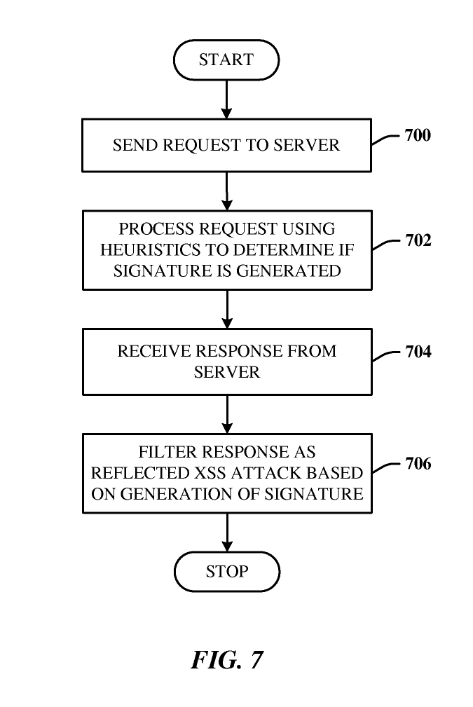

FIG. 7 illustrates a computer-implemented method of filtering a reflected XSS attack. At 700, a request is sent to a server. The request can be an HTTP request or other requests according to other suitable protocols. At 702, the request is processed using heuristics to determine if a signature is to be generated. At 704, a response is received from the server. The response can be an HTTP response, or other similar response type used for XSS attacks. At 706, the response is filtered as a reflected XSS attack based on the generation of the signature.

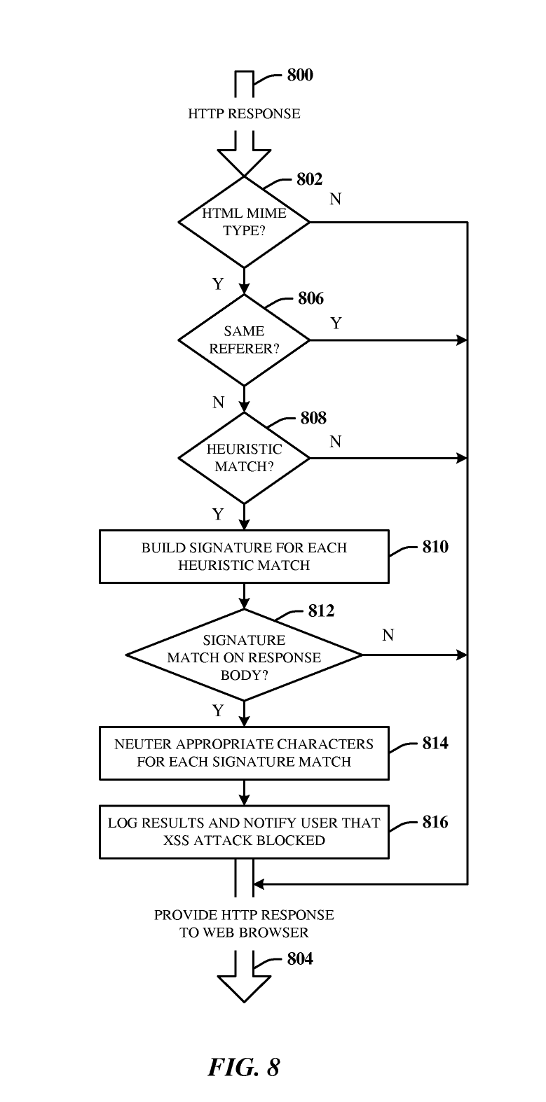

FIG. 8 illustrates an exemplary method of employing an XSS filter. At 800, an HTTP response is received. In one performance-oriented implementation, the filter only takes effect for downloaded content having a MIME type that can result in the execution of script. Accordingly, at 802, a check is made for an HTML MIME type. If the response is not an HTML MIME type, flow is to 804 to pass the HTTP response to the client web browser. If the response includes an HTML MIME type, flow is from 802 to 806 where the filter also checks the referer header in the HTTP request. If the same referer, it is same-site scripting and flow is to 804 to pass the response since no further filtering needs to be performed.

If the fully qualified domain name in the referer header does not match the fully qualified domain name of the URL being retrieved, then the request may be a cross-site script and is filtered. Thus, flow is from 806 to 808 to then find a heuristic match. If no match is found, flow is to 804 to forward the response to the web browser. The filter then takes the URL as well as any POST data associated with the request and uses regular expressions to identify specific patterns that are indicative of an XSS attack. These case-insensitive patterns are the heuristics for the filter. Following is a sample heuristic from the filter in the form of a regular expression:

{<sc{r}ipt.*?>}

The character in the inner braces { } 's in the heuristics is called a “neuter character” that will later be identified and neutered in the HTTP response. A heuristic can have one or more neuter characters. This heuristic will identify script tags. While script tags may be common in HTML, the presence of a script tag in a URL or POST data is indicative of an XSS attack. The filter can include heuristics which each identify an individual mechanism that can be used in the browser to trigger cross-site scripting. If additional mechanisms are identified in the future, new heuristics may be added to the filter.

Each neuter character (in this case the letter “r”) indicates a character that will eventually be modified by the filter in the HTTP response body in order to block the cross-site scripting attack. The character “#” can be used as the neuter replacement character—it is effective in breaking HTML elements as well as script blocks into which it is injected. The neuter replacement character can be configurable on a per-heuristic basis.

The filter's selection of neuter characters can determine whether or not the filter can be subverted; the wrong neuter characters chosen for a heuristic can result in the filter being subvert-able. As an example, picking a quote symbol as a neuter character would cause the filter to neuter quotes. A smart attacker could use this to force a match and neuter a quote on a page that actually enables a cross-site scripting attack that would not otherwise be possible.

A match on a heuristic does not necessarily trigger the filter to detect cross-site scripting; however, the match indicates to the filter that the HTTP response body will be examined to validate that the script in the input URL or POST data was in fact replayed to the output page.

As heuristics are matched, flow is from 808 to 810, where the filter generates one signature for each match. A signature is a new regular expression that will be used to scan the HTTP response body for the replayed suspect input. The neuter replacement character is temporarily put into place in the URL after a signature is matched and matching continues for a heuristic until no more matches can be found in the URL. Signatures are generated for URLs without neuter replacement characters in place. Otherwise the signatures would themselves contain neuter replacement characters and would not correctly match attacks present in the HTTP response. Consider a heuristic that will neuter a quote followed by a set of parenthesis:
′;alert( );alert( );alert( );//

Regular expressions are powerful enough to match either the first set of parenthesis or the last set of parenthesis; however, the expressions are unable to match the middle set of parenthesis. For this reason, it is desired to go through the repetitive matching/neutering process until all signatures are identified for a particular heuristic.

With each heuristic, a list of safe characters is provided. For the heuristic that detects script tags, the safe characters are the greater-than (>) and less-than characters (<) and also alphanumerics. The safe characters are characters which are important for matching purposes and essential to some form of the attack the heuristic is attempting to block. The signature-based approach is employed, since if the filter were to simply search for the match verbatim, the filter would not necessarily find the match. The web server may incidentally remove or translate particular characters. It is in fact common to observe web server behavior such as this and an attacker can use this behavior to their advantage. For example, consider if the attacker's URL looked like the following:

http://www.victim.com/page.asp?x=<SCRIPT
src$=”http://www.evil.com/evil.js”>

If the server incidentally removes dollar signs from input, the attack would not be matched. In order to avoid this type of an attack, the signature approach is used rather than verbatim text matching.

Following is an example match for the heuristic that detects script tags:
<SCRIPT src=“http://www.evil.com/evil.js”>
   The signature generated for this match would be:
<SC{R}IPT [symbol] src [symbol] http [symbol] www [symbol] evil [symbol] com [symbol] evil [symbol] js [symbol]
   Each [symbol] in the signature indicates a non-safe character from the original match. A sequence of zero to ten unspecified characters will match any [symbol] Flow is from 810 to 812 to check for signatures matches. If no signatures have been generated for a particular page, flow is from 812 to 804 where the filter permits the page to load without modification—no XSS attack was detected.

However, if signatures do exist, flow is from 812 to 814 where the filter scans the HTTP response body for each signature, and neuters the appropriate characters for each signature match. Once identified, the filter records exactly which character(s) are to be neutered, as indicated in the signature by the characters within the braces. Once all signatures have been run across the HTTP response body, the neuter characters are put into place and the HTTP response body is returned to the browser. At 816, the fact that XSS was blocked for a particular URL (and POST data, if applicable) is logged and the user is notified of an attempted XSS attack. From 816, flow is to 804 where the page will render normally except the XSS attack will be disabled.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

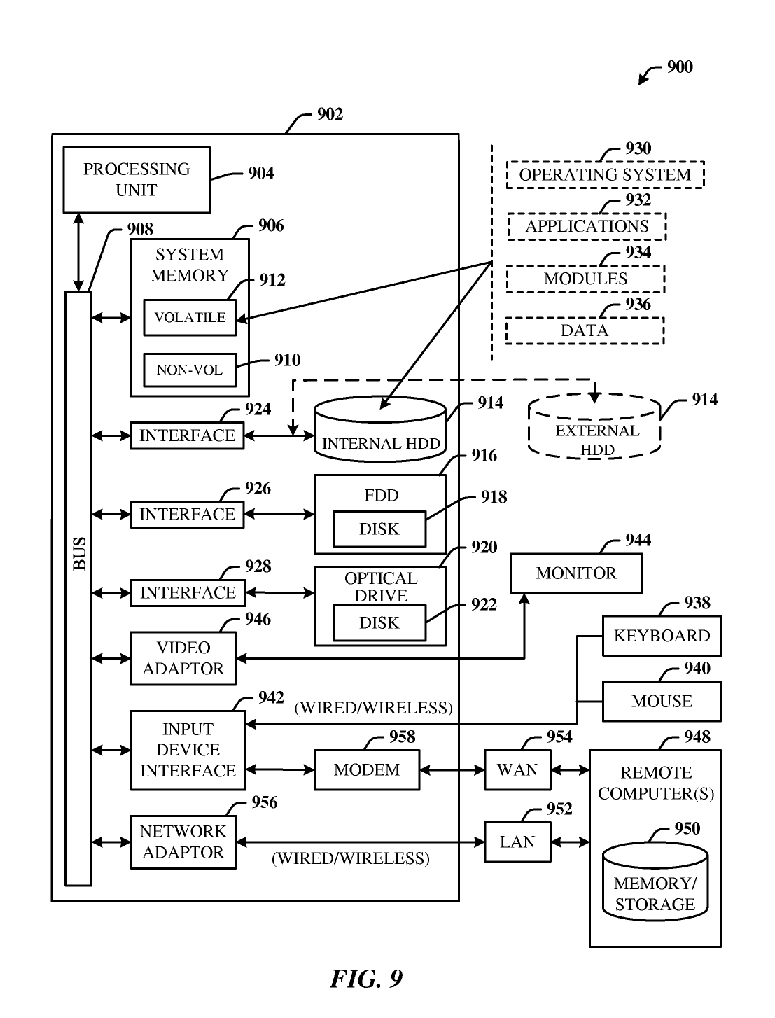

Referring now to FIG. 9, there is illustrated a block diagram of a computing system 900 operable to execute XSS filtering in accordance with the disclosed architecture. In order to provide additional context for various aspects thereof, FIG. 9 and the following discussion are intended to provide a brief, general description of a suitable computing system 900 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the exemplary computing system 900 for implementing various aspects includes a computer 902 having a processing unit 904, a system memory 906 and a system bus 908. The system bus 908 provides an interface for system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 can include non-volatile memory (NON-VOL) 910 and/or volatile memory 912 (e.g., random access memory (RAM)). A basic input/output system (BIOS) can be stored in the non-volatile memory 910 (e.g., ROM, EPROM, EEPROM, etc.), which BIOS stores the basic routines that help to transfer information between elements within the computer 902, such as during start-up. The volatile memory 912 can also include a high-speed RAM such as static RAM for caching data.

The computer 902 further includes an internal hard disk drive (HDD) 914 (e.g., EIDE, SATA), which internal HDD 914 may also be configured for external use in a suitable chassis, a magnetic floppy disk drive (FDD) 916, (e.g., to read from or write to a removable diskette 918) and an optical disk drive 920, (e.g., reading a CD-ROM disk 922 or, to read from or write to other high capacity optical media such as a DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 912, including an operating system 930, one or more application programs 932, other program modules 934, and program data 936. The one or more application programs 932, other program modules 934, and program data 936 can include the communications component 102 (e.g., a browser), the client 104, the filter component 108, XSS filter logic 110, heuristics processing component 202, heuristics 200, signatures 204, signature checking logic 206, browser 402, server firewall 504, and proxy firewall 604.

All or portions of the operating system, applications, modules, and/or data can also be cached in the volatile memory 912. It is to be appreciated that the disclosed architecture can be implemented with various commercially available operating systems or combinations of operating systems.

A user can enter commands and information into the computer 902 through one or more wire/wireless input devices, for example, a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, etc.

A monitor 944 or other type of display device is also connected to the system bus 908 via an interface, such as a video adaptor 946. In addition to the monitor 944, a computer typically includes other peripheral output devices (not shown), such as speakers, printers, etc.

The computer 902 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, is connected to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (or Wireless Fidelity) and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

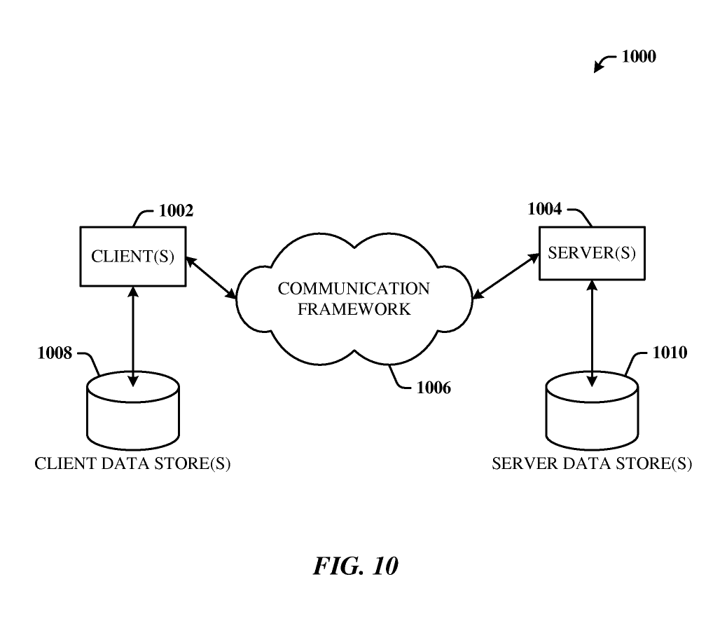

Referring now to FIG. 10, there is illustrated a schematic block diagram of an exemplary computing environment 1000 for filtering reflected XSS attacks. The environment 1000 includes one or more client(s) 1002. The client(s) 1002 can be hardware and/or software (e.g., threads, processes, computing devices). The client(s) 1002 can house cookie(s) and/or associated contextual information, for example.

The environment 1000 also includes one or more server(s) 1004. The server(s) 1004 can also be hardware and/or software (e.g., threads, processes, computing devices). The servers 1004 can house threads to perform transformations by employing the architecture, for example. One possible communication between a client 1002 and a server 1004 can be in the form of a data packet adapted to be transmitted between two or more computer processes. The data packet may include a cookie and/or associated contextual information, for example. The environment 1000 includes a communication framework 1006 (e.g., a global communication network such as the Internet) that can be employed to facilitate communications between the client(s) 1002 and the server(s) 1004.

Communications can be facilitated via a wire (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

The client(s) 1002 can include the client 104, and the server(s) 1004 can include the web server 406, server 502, and server 602. The firewalls 504 and 604 can be installed on the server systems.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for processing a cross-site scripting (XSS) attack, comprising:
a communications component for processing traffic between a client and a server; and
a filter component for filtering a reflected XSS attack from the traffic.

2. The system of claim 1, wherein the communications component is a browser of the client that sends an HTTP request to the server and the filter component operates on the client to filter the XSS attack.

3. The system of claim 1, wherein the traffic is HTTP request/response traffic and the filter component analyzes the request traffic to confirm the XSS attack in the response traffic.

4. The system of claim 3, wherein the communications component is a firewall application at the server that processes the HTTP request/response traffic, and the filter component operates as part of the firewall application to filter the XSS attack.

5. The system of claim 3, wherein the communications component is a proxy firewall application at the server, which is a proxy server or a reverse proxy server that processes the HTTP request/response traffic, and the filter component operates as part of the proxy firewall application to filter the XSS attack.

6. The system of claim 1, wherein the server disables the filter component for a particular response based on a specific HTTP response header.

7. The system of claim 1, wherein the filter component processes heuristics against outgoing traffic of the client to the server to generate signatures, and processes the signatures against incoming traffic from the server to filter the XSS attack.

8. The system of claim 1, wherein the filter component chooses one or more neuter characters for replacement in a response from the server to the client for determining occurrence of the XSS attack.

9. The system of claim 1, wherein the filter component processes one or more signatures against incoming traffic from the server to determine occurrence of the XSS attack, the attack based on content of the incoming traffic having a MIME type.

10. The system of claim 1, wherein the filter component processes all input to a script engine and when a script block is identified, the filter component scans original outgoing traffic for a request to find a script that is about to be executed and filters the script block based on a match of the script with the script block.

11. A computer-implemented system for processing an XSS attack, comprising:
a client browser for processing a request and a response between a client and a server; and
a filter component as part of the client browser for analyzing the request using heuristics and the response using signatures generated from the heuristics, and filtering a reflected XSS attack from the response traffic based on the signatures.

12. A computer-implemented method of filtering a reflected XSS attack, comprising:
sending a request to a server;
processing the request using heuristics to determine if a signature is generated;
receiving a response from the server; and
filtering the response as a reflected XSS attack based on the generation of the signature.

13. The method of claim 12, further comprising matching suspect portions of the request with reflected webpage content to determine if an XSS attack exists in the response.

14. The method of claim 12, wherein the request includes one or more of a URL or POST data.

15. The method of claim 14, further comprising employing regular expressions to identify specific patterns of characters in the one or more of a URL or POST data of the request.

16. The method of claim 12, further comprising passing through non-HTML MIME types and same-site requests without filter processing and without generating a signature.

17. The method of claim 12, further comprising checking a referer header of the request by comparing a fully qualified domain name of the referer header to a fully qualified domain name of a URL being retrieved, and filtering the request if there is a mismatch or, there is an absent or empty referrer header.

18. The method of claim 12, further comprising selecting and inserting one or more neuter characters into the heuristics to identify suspect characters in the request for modification in processing of the response.

19. The method of claim 12, further comprising generating the signature from a heuristic based on a match of a specific pattern of characters in the request as determined by the heuristic.

20. The method of claim 12, further comprising scanning the response using the signature, neutering the response using a neuter replacement character based on the signature, and returning the response to a client browser.
